(19) United States
(12) Patent Application Publication
(10) Pub. No.: US 2007/0193851 A1
(43) Pub. Date: Aug. 23, 2007

(54) Method and apparatus for filling coin magazines

(76) Inventors: Joseph P. Hanus, Watertown, WI (US); Richard P. Uecker, Hartford, WI (US); Thomas P. Adams, Oconomowoc, WI (US); Richard J. Ginsterblum, Lake Mills, WI (US)

Correspondence Address: QUARLES & BRADY LLP, 411 E. WISCONSIN AVENUE, SUITE 2040, MILWAUKEE, WI, 53202-4497, US

(21) Appl. No.: 10/591,759

(22) PCT Filed: Mar. 3, 2005
(86) PCT No.: PCT/US05/07256

§ 371 Date: Sep. 1, 2006

Related U.S. Application Data
(60) Provisional application No. 60/549,717, filed on Mar. 3, 2004.

(51) Int. Cl. G07F 1/04

(52) U.S. Cl. 194/346

(57) ABSTRACT

A method and apparatus for filling a coin magazine (30, 120, 170) has a support (20, 112, 173) for supporting the magazine, a coin feeder (40, 115, 173) for receiving batches of coins and feeding coins to a coin filling location, the coin magazine having a first channel (33, 126, 171) positioned at a coin filling location, a chute (50, 117, 148) for guiding the coins from an exit of the coin feeder to the coin filling location, a guard (60, 117, 147) positioned next to the coin filling location for preventing coins from over-shooting the coin filling location, and wherein the coin magazine is movable on the support between the second position for receiving coins in the first channel (33, 126, 171) and a third position for receiving coins in a second channel (33, 126, 171). Other embodiments are disclosed for straight line coin magazines, for lifting the coin feeding assembly to load and unload a magazine and for moving coins with a scalloped coin feeding mechanism.

### CROSS REFERENCE TO RELATED APPLICATION

The benefit of priority based on U.S. Provisional Appl. No. 60/549,717 filed Mar. 3, 2004 is claimed herein.

### TECHNICAL FIELD

The invention relates to coin dispensers, and in particular to coin dispensers of the type for dispensing change. Such coin change dispensers are found, for example, at cashier checkout locations and ticket booths and many other places.

### BACKGROUND ART

Perhaps the best known type of coin change dispenser has a vertical configuration in which a plurality of upstanding coin holding tubes are aligned in a row. Examples of such coin change dispensers are shown, for example, in Walton, U.S. Pat. No. 3,590,833 and Duplessy, U.S. Pat. No. 4,593,709.

Coin change dispensers having a circular or cylindrical coin magazine have been recently patented in Adams et, U.S. Pat. No. 6,685,551, issued Feb. 3, 2004, and Adams et al., U.S. Pat. No. 6,540,602 issued Apr. 1, 2003. This cylindrical coin magazine may provide up to thirteen or more channels for holding stacks of coins. The coin magazine can be installed and removed and carried to a different location for filling or emptying. One feature of the coin magazine is that the cylindrical coin channels have an open side for ejecting the coins. During filling operations, it is necessary that measures be taken so that coins enter the coin channels but do not fall out of the open sides.

The filling of such a coin magazine by hand may take from fifteen to twenty minutes when loading loose coins.

There is a need for an apparatus for more quickly and easily filling the coin magazines, as described above, with coins of the various denominations, as well as filling straight line magazines of the prior art. The apparatus should be compact, inexpensive and portable.

The apparatus should also allow a magazine to be easily inserted when empty and easily removed after it has been filled with coins.

It would also be advantageous to have some way of moving the magazine to bring different channels to a coin filling location. It is also necessary to fill multiple channels with the same denomination in some instances, and with different denominations in some instances.

It would be further desirable to provide some way of introducing a batch of coins into a feeder in the device, and after filling of coins into the coin magazine, removing any excess coins from the feeder.

### SUMMARY OF THE INVENTION

The invention provides a method and an apparatus for receiving batches of coins of respective denominations and feeding them to a coin filling location in which the coin channels are successively positioned for the respective denominations until the channels of the coin magazine are full or nearly full.

The invention provides a device for filling a coin magazine in five minutes or less instead of the twenty minutes necessary for a manual operation. The coin filling apparatus can hold enough coins from each denomination to fill an entire channel and possibly multiple channels with that denomination. The apparatus processes each denomination individually, but may be used to fill more than one coin channel with a particular denomination.

As one example, the method of the invention contemplates placing a coin magazine on a support; moving the coin magazine from a first position to a second position for receiving coins in the coin magazine, the coin magazine having one channel positioned at a coin filling location when the coin magazine is in the second position; placing a first batch of coins of a first denomination on a coin feeder positioned above the coin magazine in the second position; feeding individual coins towards an exit, the exit communicating with the one channel of the coin magazine positioned at the coin filling location; controlling a direction of a flow of coins as the coins leave the exit so that the coins are directed into the first channel positioned at the coin filling location; and moving a second channel of the magazine into the coin filling location.

The apparatus of the invention comprises a support for supporting a coin magazine as the coin magazine is moved from a first position for inserting the coin magazine into the apparatus to a second position for receiving coins in the coin magazine, the coin magazine having a first channel positioned at a coin filling location when the coin magazine is in the second position; a feeder positioned above the coin filling location for receiving a batch of coins of one denomination and for feeding coins towards an exit; a guard positioned at the exit for preventing coins from overshooting the coin filling location; and wherein the coin magazine is movable on the support between the second position for receiving coins in the first channel and a third position for receiving coins in a second channel.

One object of the invention is to provide a coin filling apparatus in which a coin magazine is easily loaded, filled with coins and removed for transport to a coin dispenser where it will be used.

Another object of the invention is to obviate the use of a cover, which could be slipped over the coin magazine during filling operations to assist holding the coins in their respective channels.

Another object of the invention is to provide a minimum number of parts in a coin filling apparatus, thereby reducing costs of the apparatus. In this regard, only one motor is used for a feeder and motorized power is possible but is not necessary to insert a magazine into the machine or to move the magazine during filling operations.

One advantage of the invention is that it is easily adaptable to different national coin sets and to different change capacities, such as $0.99 (US) or 19.90 Mexican pesos, as examples. One filling apparatus could be used with different magazines, including magazines with coins from different countries.

The coin magazine filling apparatus of the invention can be used in many applications. The coin magazine filling apparatus of the invention is compact, is inexpensive to manufacture and is portable.

Other objects and advantages of the invention, besides those discussed above, will be apparent to those of ordinary skill in the art from the description of the preferred embodiments which follow. In the description, reference is made to the accompanying drawings, which form a part hereof, and which illustrate examples of the invention.

### BRIEF DESCRIPTION OF THE DRAWINGS

FIG. 1 is a perspective view of a preferred embodiment of an apparatus of the present invention with a coin magazine placed into the apparatus;

FIGS. 2 and 3 are additional perspective views of the embodiment of FIG. 1 without a coin magazine;

FIG. 4 is a perspective view of a coin magazine to be filled with coins with the apparatus of FIG. 1;

FIG. 5 is top plan view of the apparatus of FIGS. 1-3;

FIG. 5a is a detail sectional view taken in the plane indicated by line 5a-5a in FIG. 5;

FIG. 6 is a side view in elevation of the apparatus of FIG. 5;

FIG. 7 is an exploded perspective view of the apparatus of FIGS. 1-3;

FIG. 8 is an exploded perspective view of a hub sub-assembly shown in FIG. 7;

FIGS. 9 and 10 are top plan views of a coin magazine of FIGS. 1 and 4 with a detail view of a guard shown in FIG. 7 in two respective operational positions;

FIG. 11 is a front perspective view of a coin filling apparatus according to a second embodiment of the invention;

FIG. 12 is a rear perspective view of a coin filling apparatus of FIG. 11;

FIG. 13 is a top plan view the coin filling apparatus of FIG. 11;

FIG. 14 is a perspective view of a coin filling apparatus according to a third embodiment of the invention;

FIG. 15 is a top plan view of the coin filling apparatus of FIG. 14;

FIG. 16 is a second perspective view of a coin filling apparatus according to a third embodiment of the invention in an open position;

FIG. 17 is a view of the coin filling apparatus of FIG. 15 with the coin magazine removed;

FIG. 18 shows the third embodiment being used to fill a straight line magazine;

FIG. 19 is a detail perspective view of a portion of the coin filling apparatus of FIGS. 14-18 handling smaller coins;

FIG. 20 is a detail perspective view of a portion of the coin filling apparatus of FIGS. 14-18 handling larger coins;

FIG. 21 illustrates examples of two types of coin magazines which can be filled using the present invention; and

FIG. 22 illustrates a variation in the coin feeding device used in the embodiments of the invention.

### DETAILED DESCRIPTION

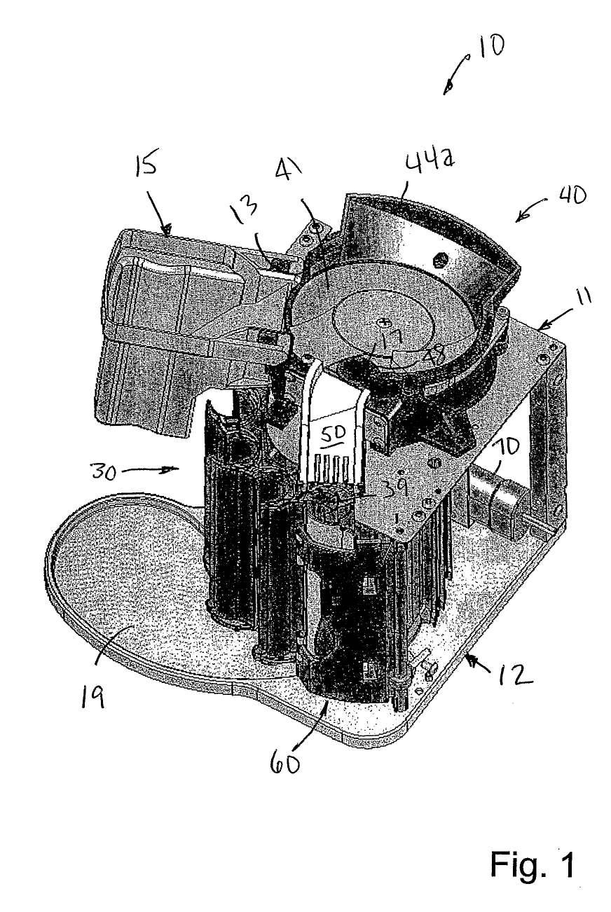

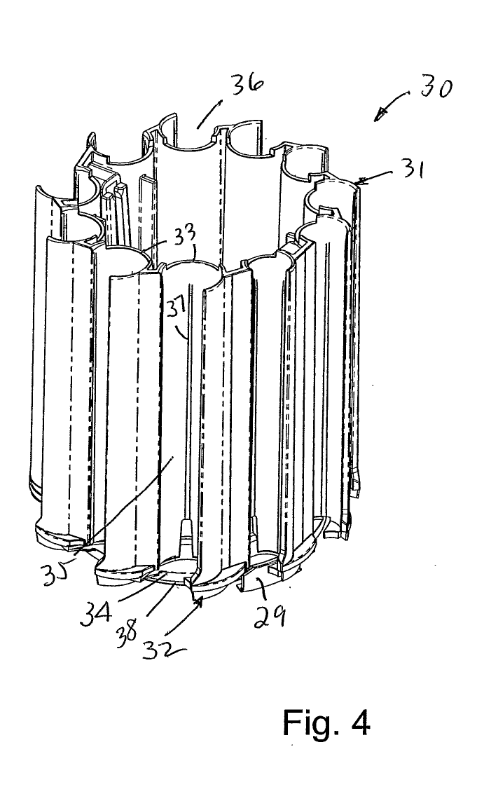

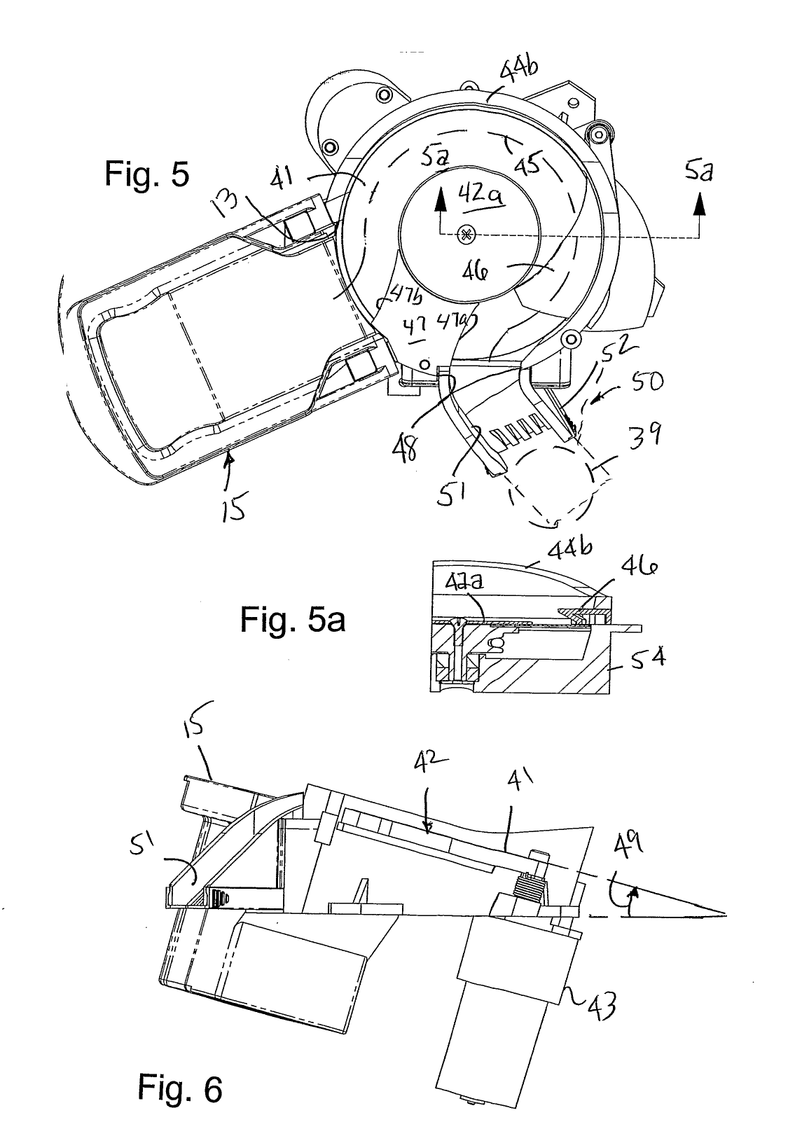

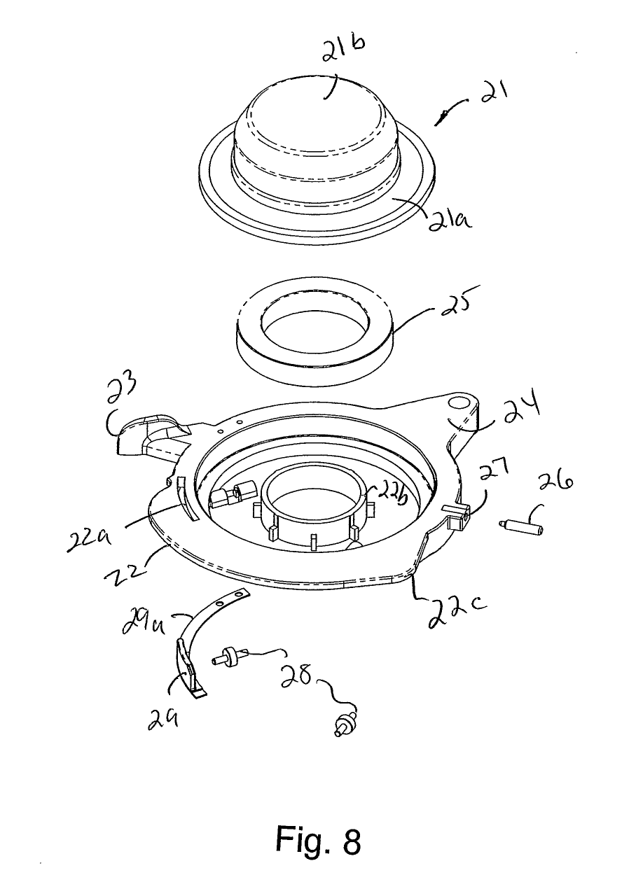

FIGS. 1-3 show a preferred embodiment of the present invention for a filling apparatus 10 for filling a coin magazine 30 to more fully described below. The filling apparatus includes a base 12, and a metal frame 11 mounted on the base 12 to support a coin feeder assembly 40. A deep-dish coin input tray 15 is seen in more detail in FIG. 7. The tray 15 is scoop-shaped molded part of synthetic material with a top opening 15f for receiving coins, a lip 15d for lifting the tray 15, and two pivot arms 15a with pivot openings 15b and integrally formed cylindrical bearing surfaces 15c. A stop 15e is formed on a front side to abut a coin feeder assembly 40. The tray 15 is pivotally mounted on two posts 16 on the coin feeder assembly 40, to be lifted for pouring a batch of coins onto a surface 41 of a disc 42 in the coin feeder assembly 40 through an entry 13 (FIGS. 1 and 5).

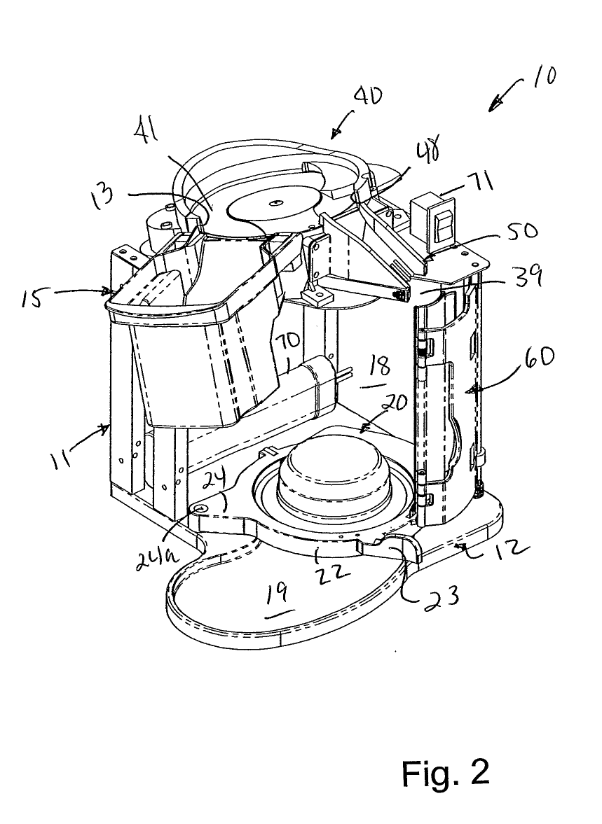

As shown in FIG. 2, the frame 11 provides a cavity 18 for receiving the magazine 30. Referring briefly to FIG. 7, the frame 11 includes a top plate 11a for supporting the coin feeder assembly and four legs 11b-11e defining the cavity 18. Returning to FIG. 2, to provide for easy insertion of the magazine a hub assembly 20 with a rotatable hub 21 and a hub base 22 are arranged to move in a recess 18 in the base 12 as the hub assembly 20 is pivoted around a pivot arm 24 and pivot point 24a. The hub assembly 20 moves between a first position in which the magazine is placed on the rotatable hub 21 and a second position where the hub assembly 20 and the magazine 30 are in a coin filling position which is seen in FIG. 1. The hub assembly 20 also has a stop arm 23 for abutting a portion of the base 12 when the hub assembly 20 reaches the second position.

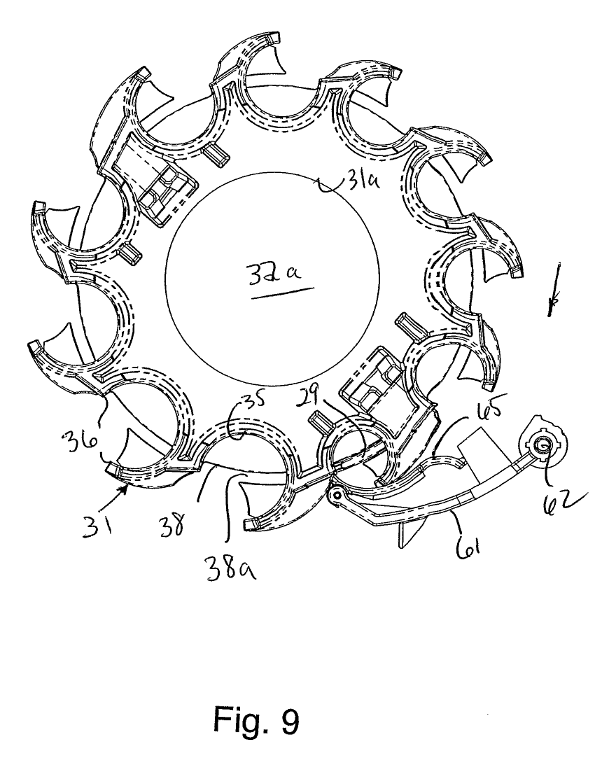

As seen further in FIG. 8, the hub 21 includes a flange 21a and a boss portion 21b. The hub base 22 is formed with a cam projection 22c for urging a guard assembly 60 away from a closed position to a non-hindering position when inserting a magazine 30 into the cavity 18. The hub base 22 includes a recess with a retainer 22b for retaining a bearing assembly 25 on which the hub 21 rotates. The hub base 22 also has a small radial slot 27 for receiving a detent 26 for location in a corresponding part of the magazine 30 to orient its position on the hub assembly 20. The hub base 22 rolls on rollers 28 in the manner of a pivotable magazine dolly. It also has an arcuate slot 22a for receiving a plug 29 that fits into the slot 38a in each coin channel 33 when the channel 33 is brought to the coin filling position. The plug 29 is supported on an arcuate arm 29a which is fastened to the hub base 22 as shown by the corresponding holes in the arm 29a and base 22.

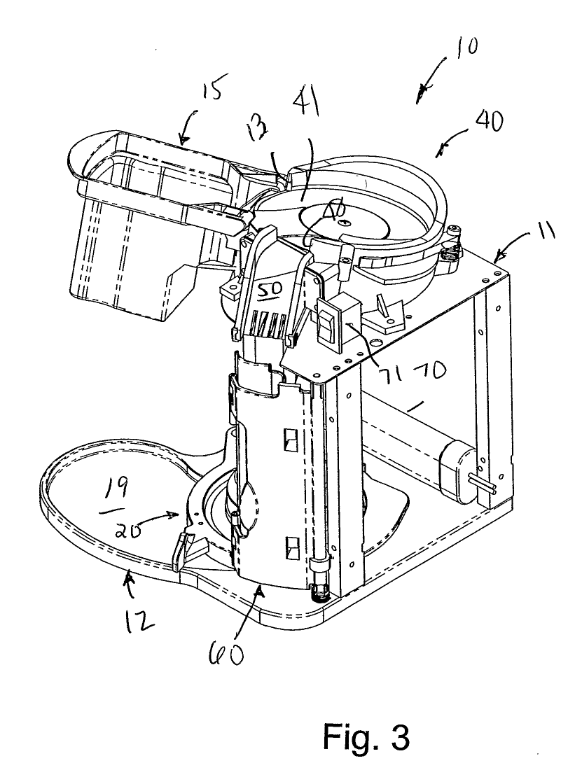

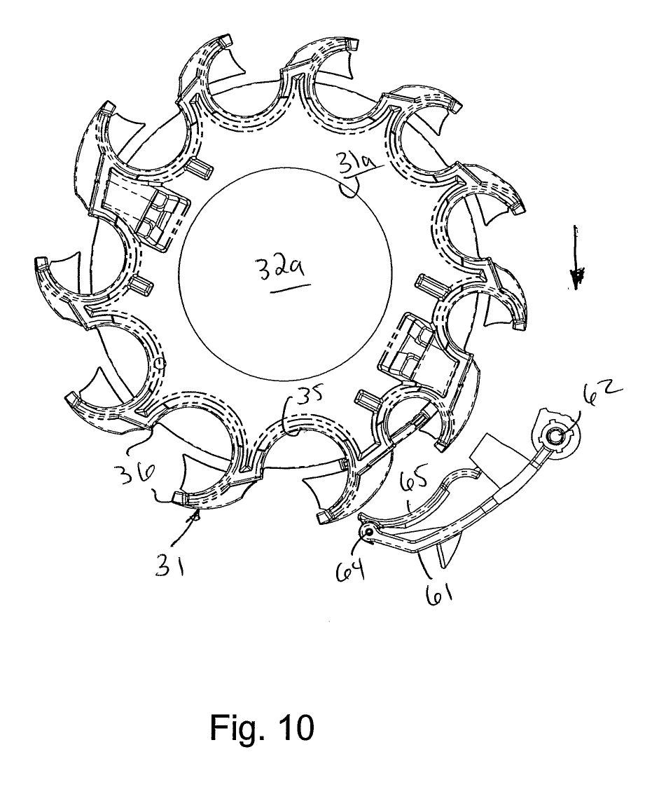

The coin magazine assembly 30 has the features of the magazine assembly described in Adams et, U.S. Pat. No. 6,685,551, issued Feb. 3, 2004, the relevant description being incorporated herein by reference. As seen best in FIG. 4, the coin magazine assembly 30 includes a ring-shaped coin magazine member 31 and a ring-shaped magazine base member 32, which are integrally molded components made of a high durability plastic material or metal. The coin magazine assembly 30 has a central opening (FIGS. 9 and 10) formed by openings 31a, 32b in the magazine 31 and base 32 for receiving the hub 21 seen in FIG. 2. The coin magazine member 31 is generally cylindrical in shape and forms longitudinally extending coin-holding channels 33 around its periphery, with coin exit openings 34 (see FIG. 4), which are one coin thickness above the floor 38 of the coin channels 33. The number of channels 33 can vary from seven to thirteen, with eleven being seen in this example.

Magazine members 31 can be provided for a variety of different mixes of coins. For example, one magazine member 31 could have coin channels with different sizes (diameters) to hold a mix of coins (pennies, nickels, dimes, quarters, dollar coins), while another magazine member 31 could have coin channels with a different mix of diameters based on the business in which the coin dispenser is used. Different coin magazines would also be used for coin sets of countries outside the United States.

Referring to FIGS. 9 and 10, the magazine base member 32 forms partial floors 38 for each channel 33. When assembled with the cylindrical magazine 31, the base member 32 forms an arcuate slot 38a for each channel 33 for receiving a pin of a coin ejector (not shown) when installed in a coin change dispenser. The slots 38a are formed along a circular path followed by the stacks of coins as the magazine assembly 30 is rotated. As seen in FIG. 9, when inserted on the hub assembly 20, the plug 29 fits into the slot 38a in each coin channel 33 when it is oriented in the coin filling position. This helps retain the first coin to be received in the bottom of the channel 33.

Referring again to FIG. 4, each channel 33 of the magazine member 31 has a sidewall 35 seen in a C-shape in cross section with a substantially vertical opening 36 in the channel sidewall 35 facing to the outside of the magazine 31. The diameter of each channel 33 varies according to the denomination of coins it will hold. Each channel 33 is formed such that the channel openings 36 face in a rearward-looking direction in relation to the counterclockwise direction of rotation of the magazine 31.

The coin magazine 31 is formed with channels 33 having a taper of not greater than 0.2 degrees, having a plurality of circumferentially spaced, zero-taper ribs 37 running up inner sidewall surfaces of the channels 33 for securely holding the coins, with the ribs 37 terminating a spaced distance from a top opening of the channels 33 to provide a slightly angled funnel to allow for easier loading of coins. Normally, in molding a part such as the magazine 31, the walls of the channels 33 would be provided with some taper for molding purposes. That has been minimized in this construction.

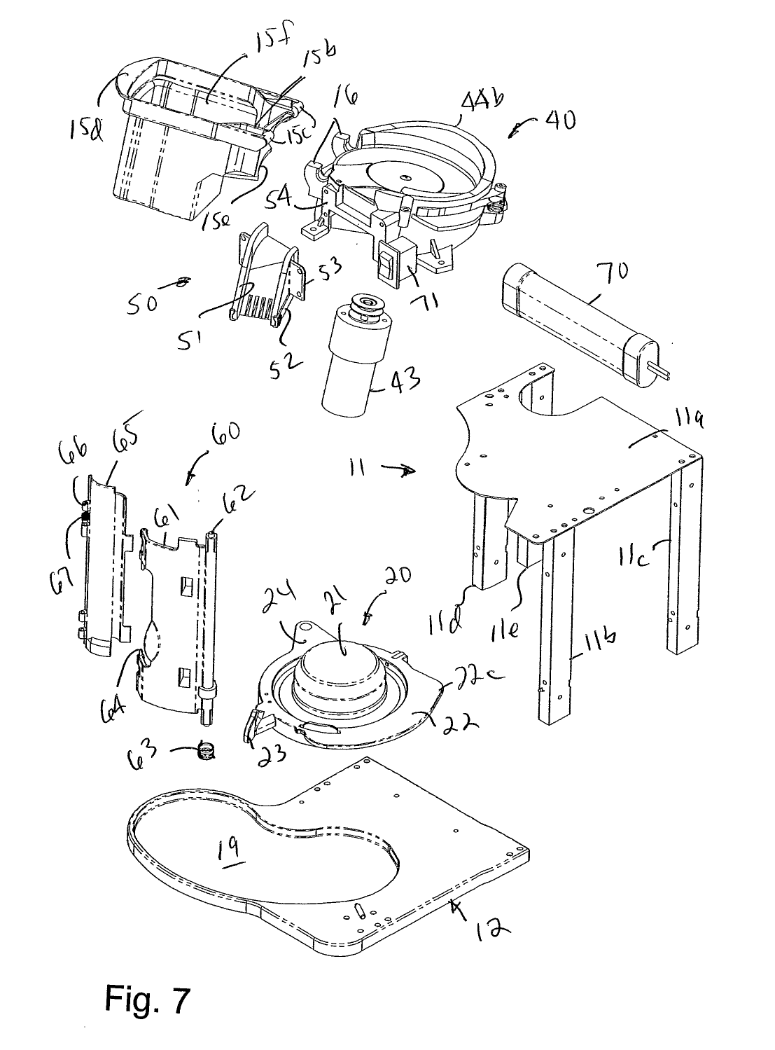

The coin feeder assembly 40 (FIGS. 1-3, 5 and 6) receives a batch of coins from the coin input tray 15 on a urethane surface 41 of a disc 42 (seen in elevation in FIG. 6) The disc 42 is rotated by a motor 43 (FIGS. 6 and 7). Power for the motor is provided through an AC power supply adapter (not shown) or from a battery 70 (FIGS. 1-3) A switch 71 (FIGS. 2-3) is mounted on the coin feeder assembly 40 with on and off positions for energizing and de-energizing the motor 43. The switch 71 can also be a three-way switch with forward, off, and reverse positions for energizing the motor in opposite rotational directions.

When the motor is operating in a forward direction, the disc 42 is rotated in a clockwise direction to feed coins 17 in single file to a coin exit 48. An elevated sidewall 44a, 44b, which is scoop-shaped in FIG. 1, but is preferably straight as shown in FIGS. 2, 3 and 5, is provided along the feed path 45 (FIG. 5) to contain excess coins until they can be arranged in single file (queued). A coin knocker 46 (seen in sectional elevation in FIG. 5a) is positioned along the arcuate feed path 45 to knock off coins on top of the bottom layer of coins and push them to the middle for another cycle through the coin feeder 40. A raised disc hub 42a in the center of disc 42 directs coins back onto the surface 41. A coin point 47 is provided with a first reference edge 47a to guide the single layer, single file of coins to a coin exit 48 in a sidewall around the feeder. A second reference edge 47b guides coins back to the tray 15 when rotation of the disc 42 is reversed. A coin chute 50 is provided at the exit 48 and its path is on an arc from a radius of the coin feeder disc 42 to provide a reference edge 51 for coins passing through the chute 50. The chute 50 opens to a coin filling location 39, where a coin channel 33 is positioned to receive coins as they leave the chute 50.

As seen in FIG. 7, the chute 50 has a slidable extension 52 in its retracted position. When the extension 52 is in its extended position, and the motor 43 is energized in a forward feeding direction, coins 17 will be fed over the coin filling location 39 (as shown in phantom in FIG. 5) to a receptacle to remove excess coins of one denomination. The chute 50 has flanges for mounting the chute 50 on a portion of a disc feeder base 54.

As seen in FIG. 6, the coin feeding disc 42 is oriented at an acute angle 49 of approximately fifteen degrees from horizontal along an axis from a back of the coin feeder to the coin exit 48 which is at a front of the coin feeder 40.

Referring to FIGS. 1, 7, 9 and 10, the filling apparatus 10 also includes a guard assembly 60 having a pivotable support flap 61 pivotably mounted by pin(s) 62 for pivoting around a vertical axis. The flap 61 is biased by a torsion return spring 63 so that it is pressed against the outside of the magazine 31 as it is rotated. A guard flap 65 is hinged on hinge pins 64 to a free edge of the support flap 61 and extends back across a face of the support flap 61. The guard flap 65 has an irregular and varying curve in profile, as seen in FIGS. 9 and 10, so as to be able to close channels 33 of both large and small diameter and of intermediate diameters. The guard flap 65 is also spring-biased by a torsion spring 67, as seen in FIG. 7, to maintain pressure against the outside of the magazine 31 while yielding to rotational movements of the magazine 31.

Referring to FIG. 2, to load a magazine 31 with coins the magazine is first placed on the hub assembly 20 in its a position outside the cavity 18 with the plug 29 in position in one channel. The coin guard assembly 60 is in a closed position. The magazine 30 is then moved into cavity 18 by pivoting the hub assembly 20, with the cam projection 22c urging the guard assembly 60 to a non-hindering position to let the magazine 30 and the hub assembly 20 pass by. The channel with the plug will be brought to the coin filling position 39. The coin guard assembly 60 is then returned to a closed position against the magazine 30 (FIG. 9) by the force of the return springs. The motor 43 is started by operating the switch 71 and a first batch of coins residing in the coin input tray 15, is poured onto the coin feeder surface 41. From there the coins are arranged in a single layer with the help of the coin knocker 46 (FIG. 5) and are fed single file to the coin exit 48, where they are guided by the reference edge 51 to the coin filling location 39. There they enter the coin channel 33 and are prevented from overshoot by the coin guard assembly 60 (FIG. 1). When the channel 33 has been filled, the feeder motor 43 is switched off and the magazine 30 is rotated one channel position by hand or by pressing a button (not shown) on the hub assembly 20 to actuate a small motor (not shown) in the hub assembly 20. As seen in FIGS. 9 and 10 (FIG. 10 being earlier in sequence of rotation than FIG. 9), the coin guard 65 rides along the outside of the cylinder 31 to close off the next channel 33 as it comes to the coin filling position 39. The feeder motor 43 is switched on in a forward direction to continue feeding the same denomination into the next channel 33.

In the event that a second denomination is to be loaded, the switch 71 is moved to a reverse position, which reverses the direction of rotation of the feeding disc 42. The coins on the disc 42 are returned to the coin input tray 15, with the aid of the reference edge 47b seen in FIG. 5. The tray 15 can be emptied or swapped for another receptacle having a second denomination with coins of a different diameter than the first denomination. The magazine 30 is rotated one channel position and the feeder motor 43 is switched on in the forward direction for feeding the second denomination into the channel in the coin filling position. In this manner, the magazine 30 can be filled with various denominations, some of which occupy more than one coin channel 33.

As an alternative for unloading excess coins of the first denomination, the chute extension 52 can be extended (as shown in phantom in FIG. 5), and the feed motor 43 could be energized in a forward direction to discharge excess coins over the coin filling location 39 into a collection receptacle.

The magazine 30 is then removed by first pivoting open the coin guard assembly 60 and then pivoting the hub assembly 20 to its position outside the cavity 18 which is below the coin feeder assembly 40. The coin magazine 30, which is now filled with coins can be lifted off the hub assembly 20 and transported with the aid of a carrying handle (not shown).

The filling of a coin magazine by hand may take from fifteen to twenty minutes when filling with loose coins. The invention provides a device for filling a coin magazine in approximately five minutes instead of the twenty minutes necessary for a manual operation. The device is portable and will handle magazines of differing configurations, even straight-line instead of circular configurations.

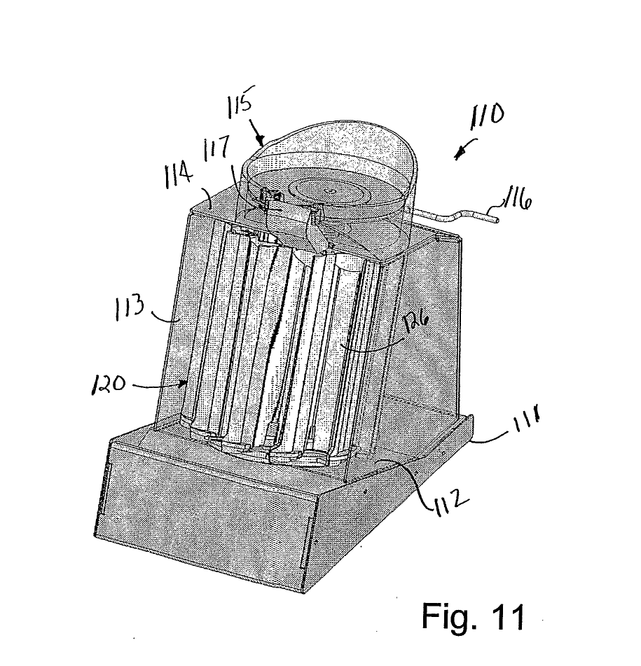

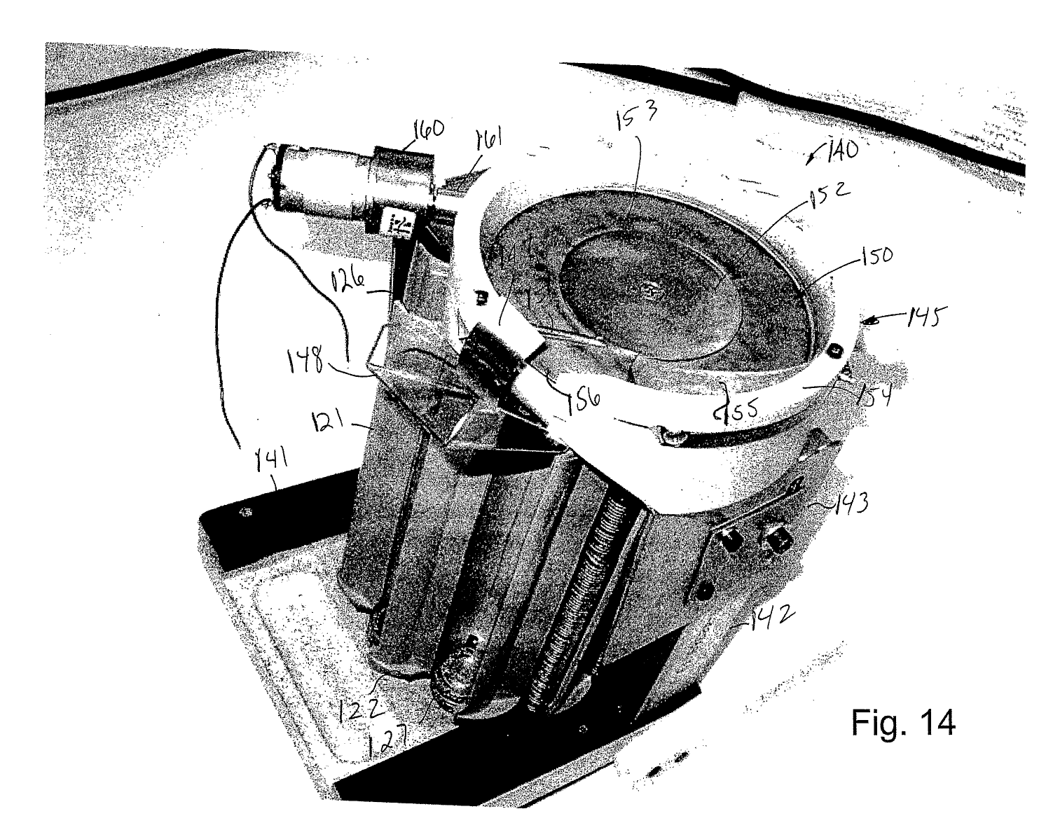

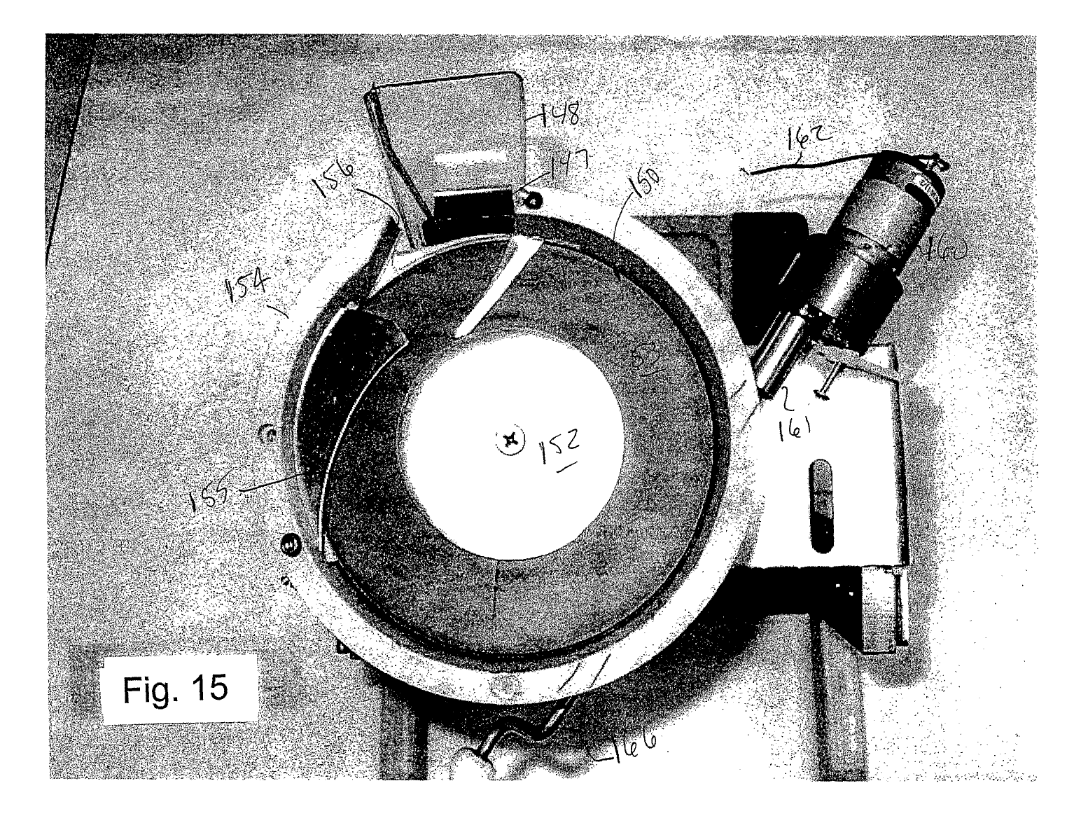

Further examples of a coin magazine filling apparatus 110, 140 according to the present invention are illustrated in FIGS. 11-23. As shown in FIG. 11, a cylindrical coin magazine 120 is disposed in the apparatus 110 for filling with coins. The coin magazine 120 is described in detail in Adams et al., U.S. Pat. No. 6,685,551, issued Feb. 3, 2004 and shown in FIG. 4. The magazine 120 is formed with a plurality of upstanding coin channels 126, in this example, numbering twelve. As seen in FIG. 11-13, the coin channels 112 are empty, however, in use, these channels 126 would hold stacks of coins, each channel 126 being dedicated to a corresponding denomination, as illustrated in FIGS. 14 and 15. It may be also be advantageous to have more than one stack of coins for certain denominations, such as pennies/ for example, in making up $0.99 change for one U.S. dollar.

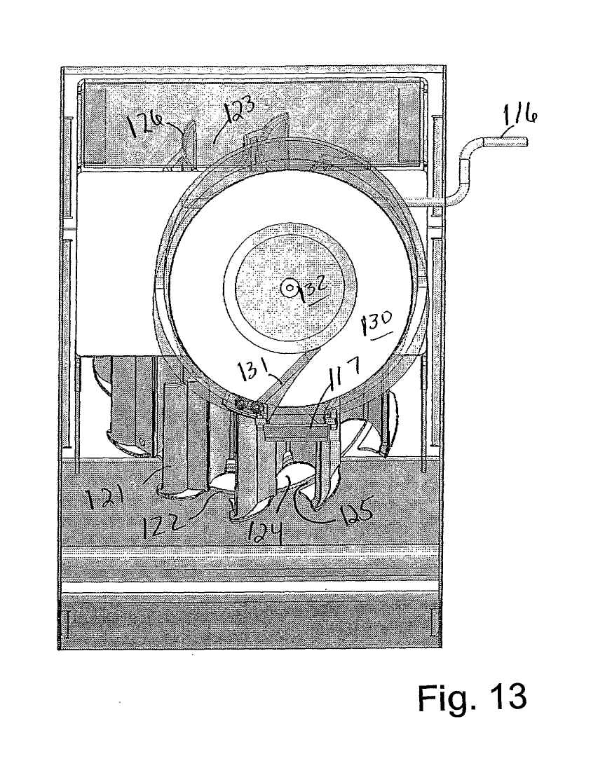

As seen best in FIG. 11-13, the coin magazine assembly 120 includes a cylindrical coin magazine member 121 and a ring-shaped magazine base member 122, which are integrally molded components made of a high durability plastic material or metal. The coin magazine member 121 is generally cylindrical in shape and forms a plurality of longitudinally extending coin-holding channels 126 around its periphery, with coin channel openings 123 (FIG. 13) through its outer surface. As seen best in FIG. 13, each channel 126 has a sidewall seen in a C-shape in cross section with an opening 123 in the channel sidewall facing to the outside of the magazine assembly 120. The diameter of each channel 126 varies according to the denomination of coins it will hold.

Referring to FIG. 13, magazine base member 122 forms partial floors 124 for each channel 126. When assembled with the cylindrical magazine 121, this member 122 forms an arcuate slot 125 for each channel 126 for receiving a pin of a coin ejector (not shown). The slots 125 are formed along a circular path followed by the stacks of coins as the magazine assembly 120 is rotated.

As seen in FIG. 11, the filling apparatus 110 has a base 111 with an inclined ramp 112 of approximately eighteen degrees from horizontal. The coin magazine 120 is disposed in the apparatus on the ramp 112 so as to be tilted at an angle of about eighteen degrees from vertical. This aids the feeding of coins into the coin channels 126. The apparatus also has side walls 113 rising from the base 111 and a top cover 114 that pivots upward from the side walls 113 to open the apparatus 110 when inserting or removing coin magazines 120.

Positioned on the top cover 14 is a coin feeding mechanism 115 which receives a batch of coins of a particular denomination and arranges them into a single file for feeding to a diverter chute 117 that directs the coins into a top end of a channel 126 positioned just below the chute 117.

A feed disc 130 is positioned from rear to front at an angle of about fifteen degrees from horizontal to aid the shedding of coins and ensuring that one layer of coins is fed upwardly towards the entrance to the chute 117.

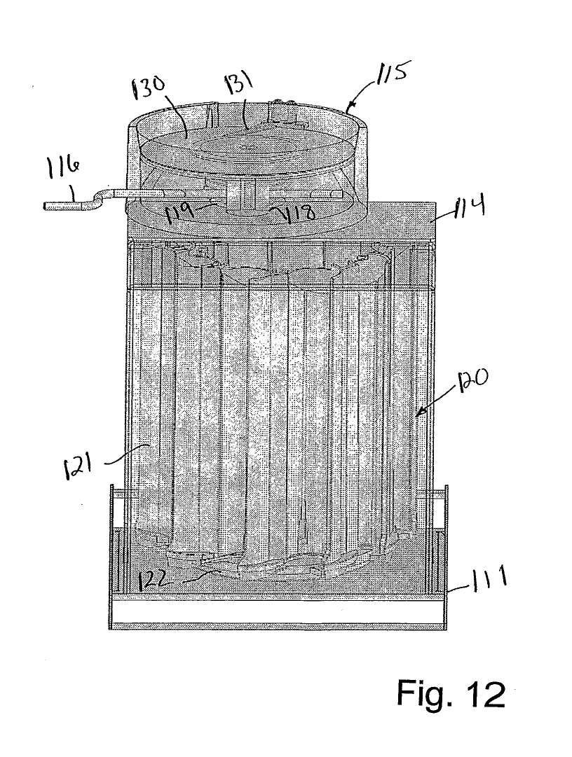

The coin feeding mechanism 115 is powered in this example by a hand crank 116. Referring next, to FIG. 12, the crank has a pulley 118 which receives one end of a belt (not shown) which has an opposite disposed around a pulley 119 on a shaft (not shown) attached to the disc 130 for rotating the disc 130 when the crank is operated. As seen in FIG. 13, there is also a central hub 132 on the disc 130 for assisting in directing the coins toward a coin point 131.

Further details of the apparatus 140 are illustrated in FIGS. 14-17. The apparatus 140 includes a base 141, upright frame members 142 rising from the base and a pivotable upper frame structure 143, which supports a coin feeding mechanism 145. A coin magazine 121, 122 with stacks of coins 127 is positioned in a cavity in the apparatus formed into the base 141, between the upright members 142 and beneath the pivotable upper frame structure 143. In practice, a ramp would be provided, as shown in FIG. 11, so that the coin magazine 121, 122 is tilted at an angle to receive coins.

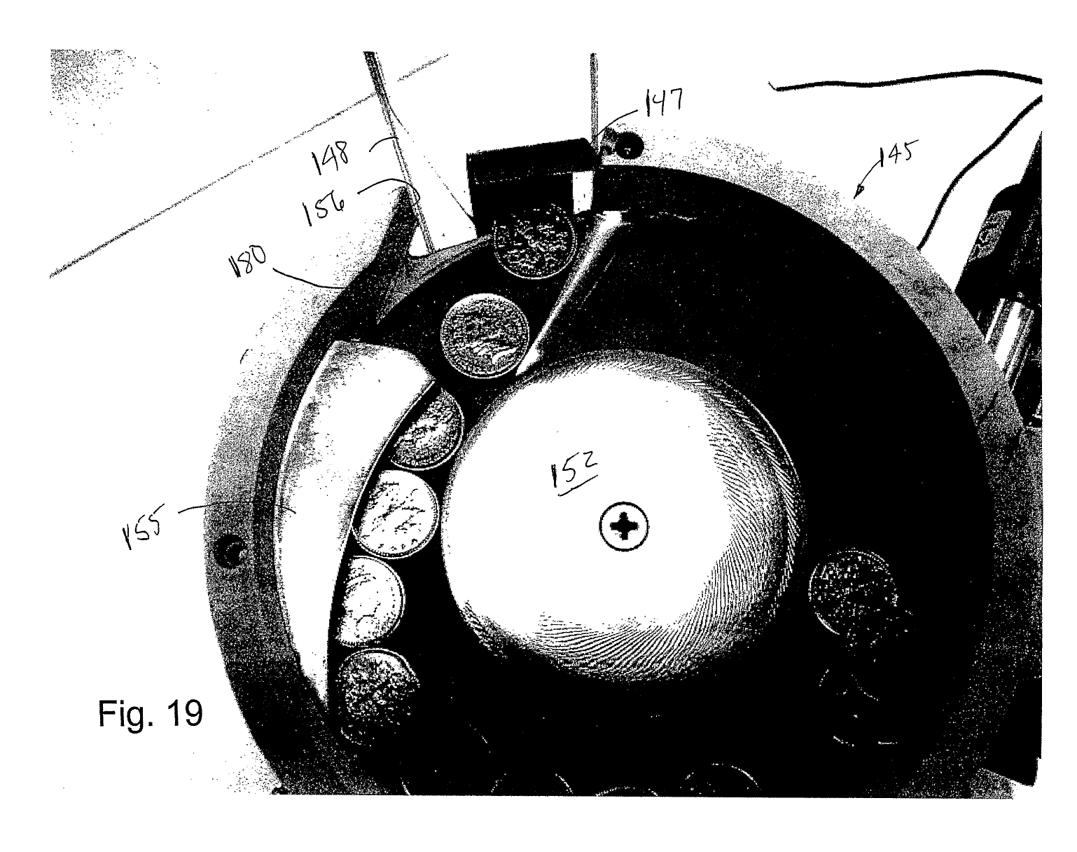

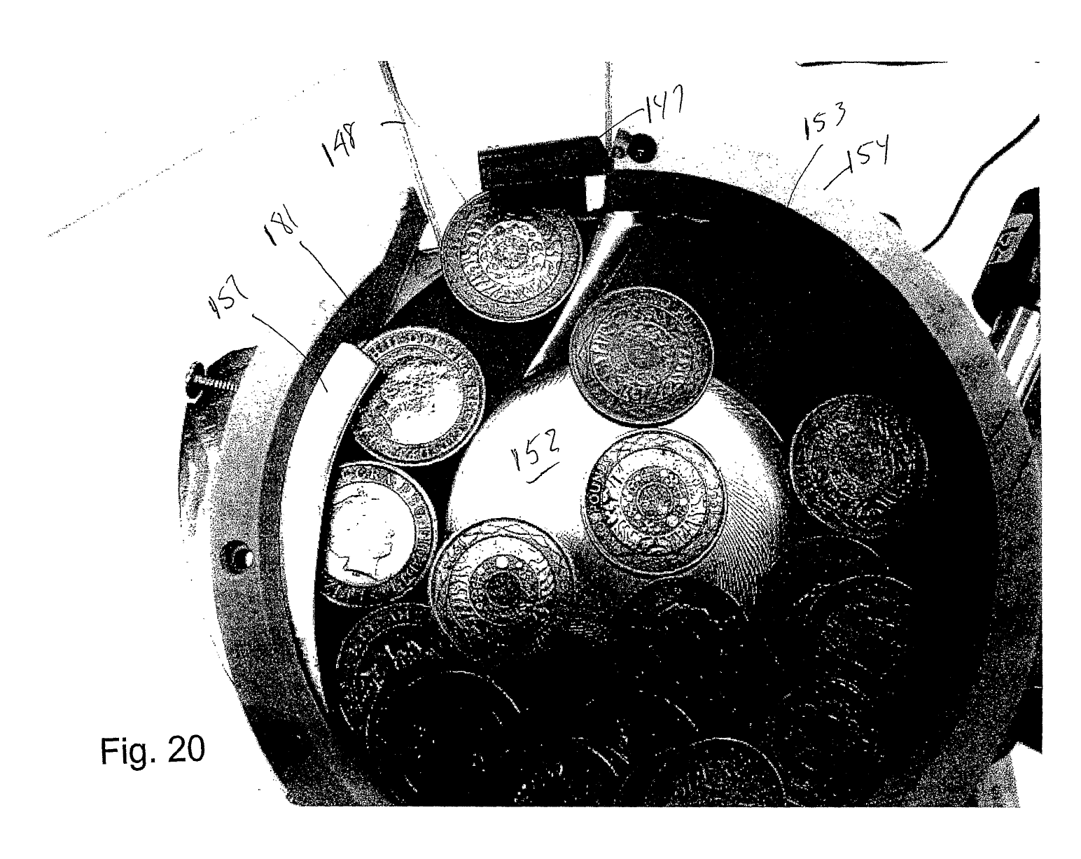

The coin feeding mechanism 145 includes a rotatable disc 150 with a coin track portion 153 that extends around the disc 150 between a side wall 154 and a central hub 152. As seen in FIG. 15, there is a coin bumper 155 along the inside of the side wall 154 leading towards a coin point member 151 which further leads to a coin exit 156. The coin feeding mechanism 145 will arrange the coins 180 in FIG. 19 and 181 in FIG. 20 in single file before they reach the exit 156. The bumper 155 in FIG. 19 and 157 in FIG. 20 will tend to bump off coins that become stacked on the bottom layer of coins. These coins will be moved across the hub 152 to start again on the coin track portion 153. The hub 152 also forms an inside edge for coins on the bottom layer which next encounter the coin point member before exiting the disc through exit 156.

As seen in FIGS. 14 and 15, the disc 150 can be powered through a hand crank 166 or through a motor 160. The motor 160 has a shaft 161 which would be connected through a drive belt (not shown) to a shaft on the disc 150. Electric power would be supplied to the motor 160 through leads 162. The unit could be provided with a battery as a source of power.

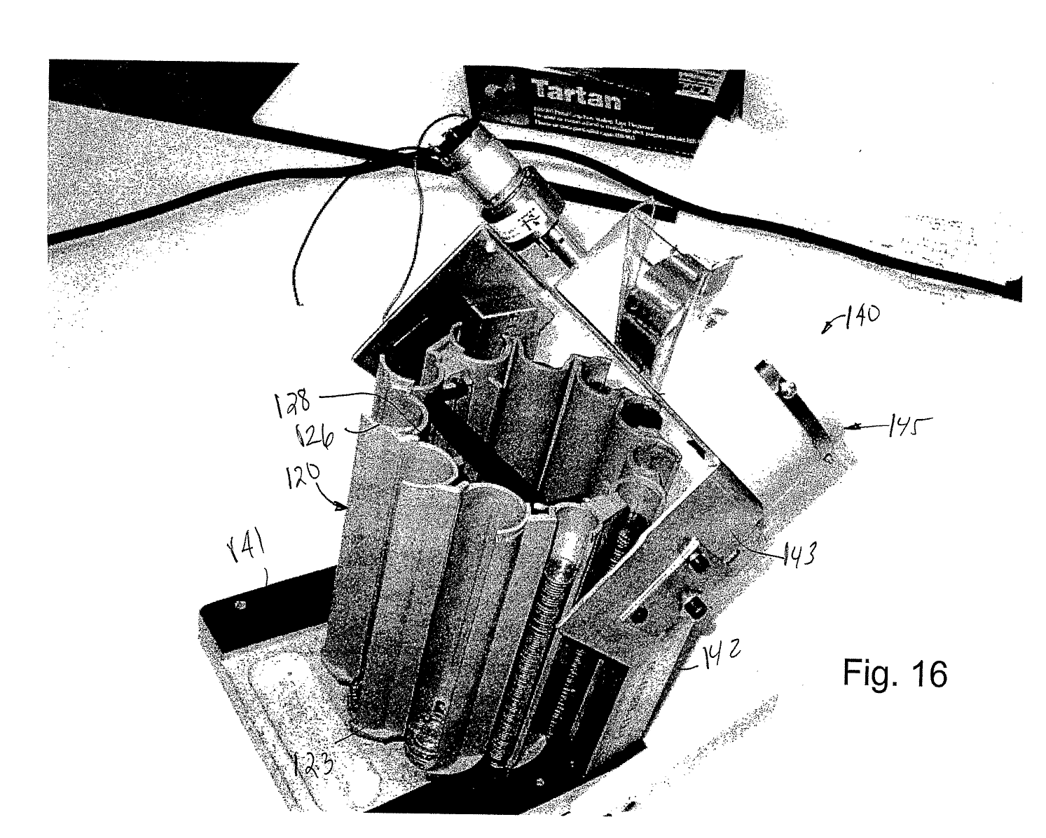

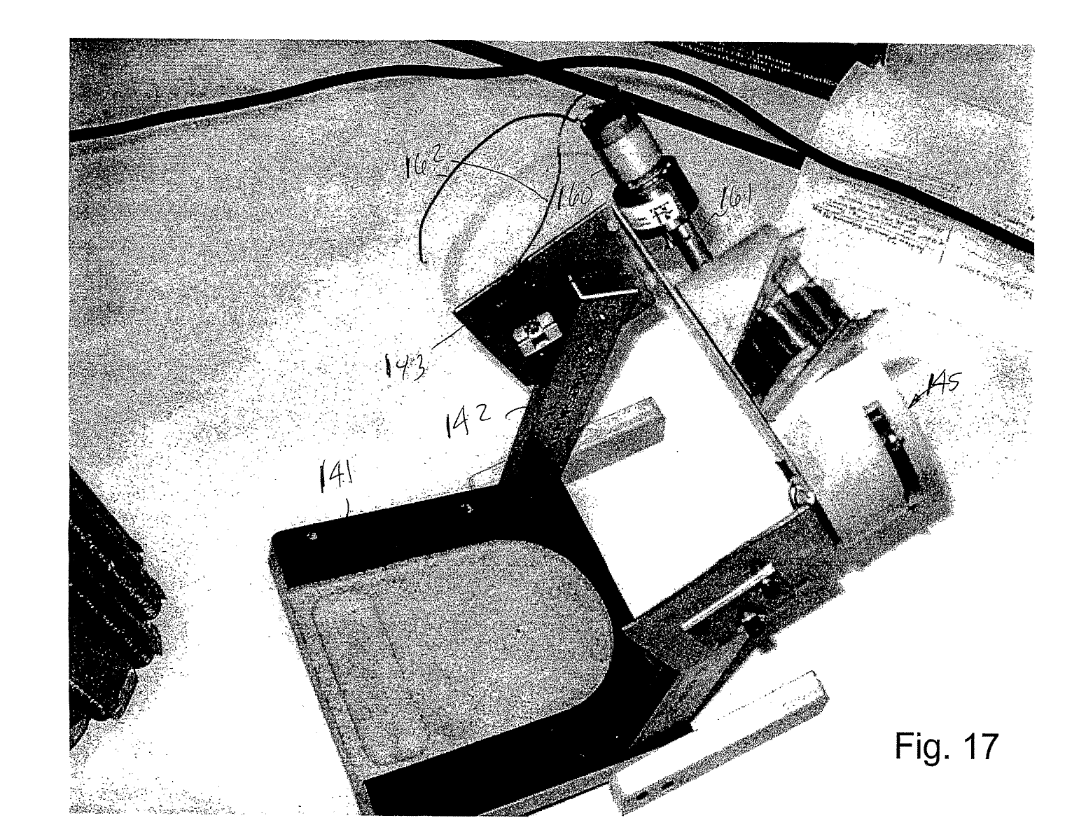

FIG. 16 shows how the coin feeding mechanism 145 can be tilted upward by pivoting the upper frame structure 143 for removal or insertion of a coin magazine 120. FIG. 17 shows an empty coin filling apparatus 140 in which the coin feeding mechanism is pivotably mounted for the coin feeder is pivoting upward to allow easy clearance of the coin magazine as it is moved to the coin filling position.

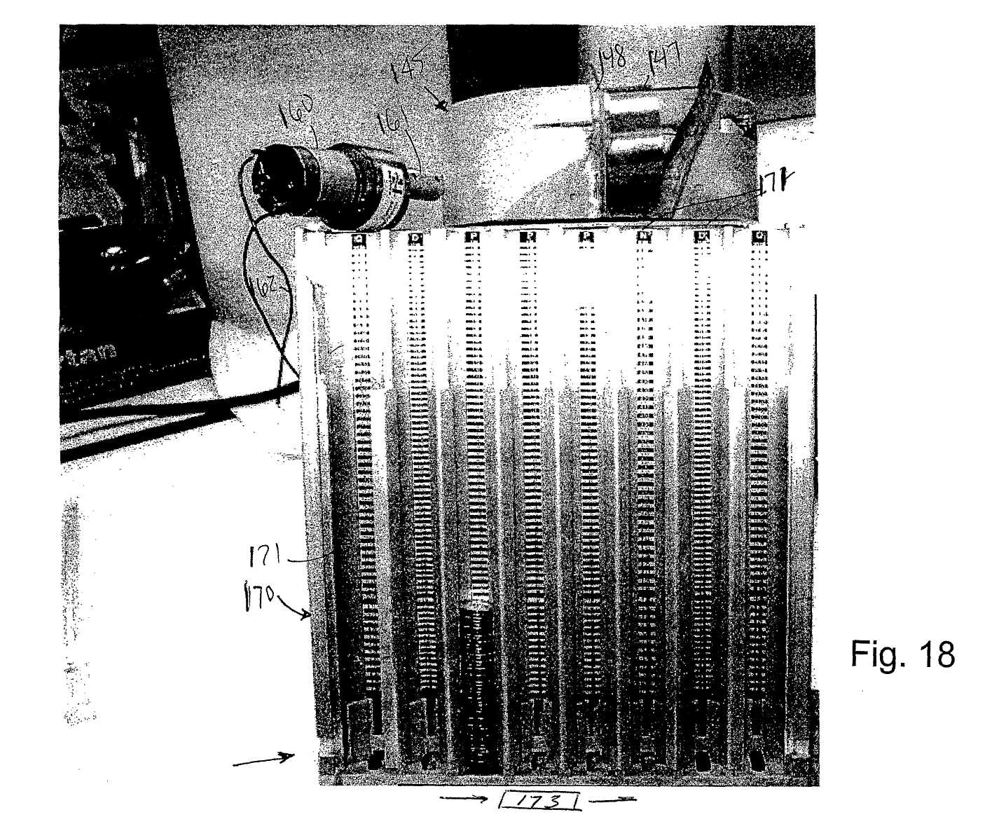

FIG. 18 shows the coin filling apparatus of FIGS. 14-17 applied to a straight line coin magazine. A linear feed mechanism 173 of a type generally known in the art can be provided for sliding the magazine by the coin exit chute 147, 148 to fill succeeding coin channels 171.

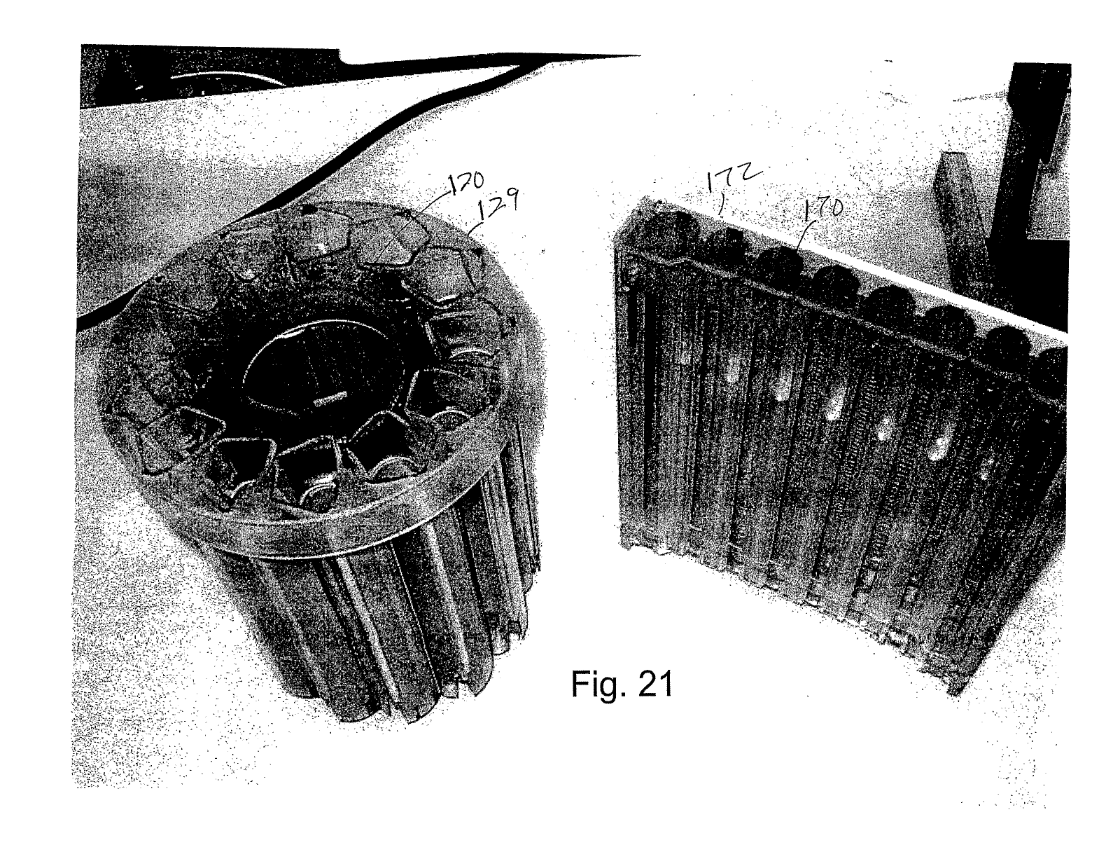

As seen in FIG. 21, a, cover 219 is available for covering the magazine 120 to assist the loading of coins therein or for transport. One object of the present invention is to obviate the need of such a cover 129 when filling the magazines 120 with coins. Once the coins are loaded, it is possible to place the cover 129 over the magazine and transport it by gripping a handle 128 seen in FIG. 16. It is also typical to use a cover 172 with the inline coin magazine 170, but this would not be necessary when loading coins with the filling apparatus of the present invention.

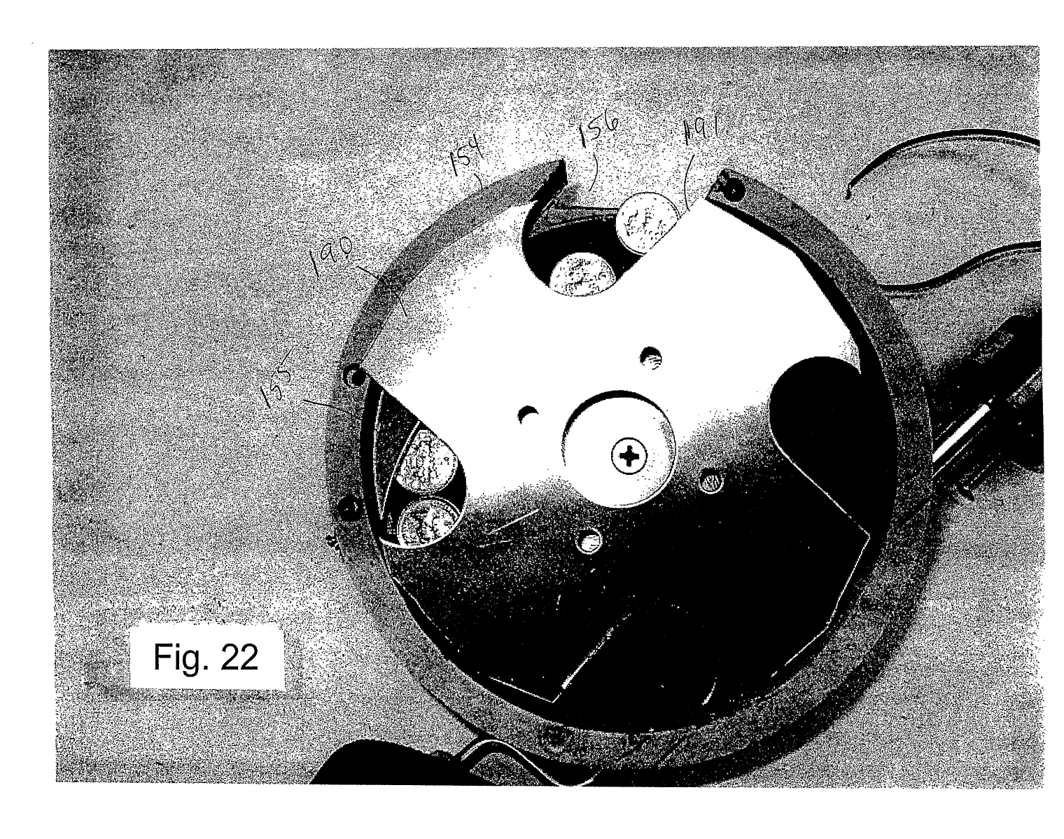

FIG. 22 shows an alternative to the feeding mechanism 145 in which a plate 190 with four scallop cut-out portions 191 would be used to pick up coins dumped into the hopper defined by the side wall 154 and convey them one at a time to the coin exit 156. The scallop cut-out portions 191 can be sized to pick up multiple coins or only one coin each. The pickup plate 191 would be mounted on a drive hub comparable to hub 152, to be driven by the mechanical power output shaft.

The invention also contemplates a visual alignment device for signaling or showing the user that a coin channel is properly aligned with the coin exit 156.

This has been a description of a preferred embodiment and several alternative embodiments of the invention the description has been provided by way of example an illustration and not by way of limitation, except as defined by the scope of the following claims.

1. A method for filling a coin magazine having a plurality of channels for receiving coins of a plurality of denominations, the method comprising:
placing a coin magazine on a support;
moving the coin magazine from a first position to a second position for receiving coins in the coin magazine, the coin magazine having one channel positioned at a coin filling location when the coin magazine is in the second position;
placing a first batch of coins of a first denomination on a coin feeder positioned above the coin magazine in the second position;
feeding coins towards a coin exit, said coin exit communicating with the one channel of the coin magazine positioned at the coin filling location;
controlling a direction of a flow of coins as the coins leave the exit so that the coins are directed into the first channel positioned at the coin filling location; and
moving a second channel of the magazine into the coin filling location.

2. The method of claim 1, further comprising placing a second batch of coins of a second denomination on the coin feeder, which is positioned above the coin magazine, and feeding the coins of the second denomination into the second channel.

3. The method of claim 1, wherein the feeding of coins is stopped before moving the second channel into the coin filling location and wherein the feeding of coins from the first batch is restarted to feed coins of the first denomination into the second channel.

4. The method of claim 1, wherein when it is desired to remove the coin magazine that has been filled with coins, moving the coin magazine from the second position to the first position.

5. The method of claim 1, wherein prior to moving the coin magazine from the first position to the second position, the coin feeder is pivoted upward to allow clearance of the coin magazine as it is moved to the second position.

6. The method of claim 1, wherein prior to moving the coin magazine from the first position to the second position, the coin feeder is placed on a movable support which is then moved to move the coin magazine to the second position.

7. The method of claim 6, wherein the support is pivoted into and out of the second position below the coin filling location.

8. The method of claim 7, wherein the coin magazine is cylindrical and wherein the coin magazine is rotated on the support to move the second channel of the magazine into the coin filling location.

9. The method of claim 1, wherein the feeding is powered by hand operation.

10. The method of claim 1, wherein the feeding is powered by an electric motor.

11. The method of claim 1, wherein placing the first batch of coins of one denomination on a coin feeder includes lifting up a pivotable coin input tray where coins of one denomination have been initially placed to move the coins onto a feeding surface.

12. The method of claim 1, wherein a direction of feeding of the coins is reversed to feed coins back into a coin input tray.

13. The method of claim 1, wherein the coin magazine has coin channels arranged in a straight line and wherein moving the second channel of the magazine into the coin filling location is a linear movement of the magazine along a straight line path.

14. The method of claim 1, wherein the coins are arranged in a single file and the single file is advanced to the coin exit.

15. The method of claim 1, wherein individual coins are separated from the first batch and then individually conveyed to the coin exit.

16. The method of claim 1, wherein the coin feeder is oriented at an acute angle of approximately fifteen degrees from horizontal along an axis from a back of the coin feeder to the coin exit which is at a front of the coin feeder.

17. The method of claim 16, further comprising moving a guard away from a closed position while moving the coin magazine from the first position to the second position for receiving coins in the coin magazine, the guard assisting in directing coins into a coin channel having an open side.

18. The method of claim 16, wherein the coin magazine is placed on the support, which is stationary and which is oriented at an acute angle of approximately eighteen degrees from horizontal along an axis from a back of the support to a front of the support.

19. The method of claim 1, wherein a chute extension is extended and wherein excess coins of the first denomination are fed in a forward direction over the coin filling location to a receptacle.

20. An apparatus for filling a coin magazine having channels for receiving coins of a plurality of denominations, the apparatus comprising:
a support for supporting a coin magazine as the coin magazine is moved from a first position for inserting the coin magazine into the apparatus to a second position for filling coins into the coin magazine, the coin magazine having a first channel positioned at a coin filling location when the coin magazine is in the second position;
a feeder positioned above the coin filling location for receiving a batch of coins of one denomination and for feeding coins towards a coin exit;
a guard positioned at the coin filling location for preventing coins from overshooting the coin filling location; and
wherein the coin magazine is movable on the support between the second position for receiving coins in the first channel to a third position for receiving coins in a second channel.

21. The apparatus of claim 20, wherein the coin magazine has at least a first channel and a second channel for receiving coins of a same denomination and a same size.

22. The apparatus of claim 20, wherein the coin magazine has at least a first channel and a second channel for receiving coins of different respective denominations and different respective sizes.

23. The apparatus of claim 20, wherein the coin magazine is cylindrical.

24. The apparatus of claim 20, wherein the coin magazine has coin channels arranged in a straight line.

25. The apparatus of claim 20, wherein the feeder is a disc feeder that is moved by manual power.

26. The apparatus of claim 20, wherein the feeder is a disc feeder that is powered by an electric motor.

27. The apparatus of claim 20, wherein feeder is a disc feeder that arranges the coins in a single file and them advances the single file to the coin exit.

28. The apparatus of claim 20, wherein the feeder is a disc feeder with a scalloped feeding member with pockets for individual coins that separates individual coins from a batch and conveys the coins to the coin exit.

29. The apparatus of claim 20, further comprising a pivotable coin input tray for holding coins and for lifting to move coins onto the feeder through an entry between the coin input tray and the feeder.

30. The apparatus of claim 20, wherein the feeder is a disc feeder that is rotatable in a first rotational direction to feed coins to the exit and that is rotatable in a second rotational direction to return coins through the entry from the coin input tray.

31. The apparatus of claim 20, wherein the coin channels each have an open side and wherein the guard is positioned on a pivotable flap that is closed to close the open side and to project above the coin channel to direct coins into the first coin channel.

32. The apparatus of claim 20, wherein the guard is mounted opposite the exit to deflect coins downward and to reverse direction of the coins into the first coin channel.

33. The apparatus of claim 20, wherein the coin feeder is mounted for pivoting upward to allow clearance of the coin magazine as it is moved to the second position.

34. The apparatus of claim 20, wherein the support is movable, and wherein the coin magazine is placed on the support, which is then moved to move the coin magazine to the second position.

35. The apparatus of claim 34, wherein the support is pivoted into and out of the second position below the coin filling location.

36. The apparatus of claim 35, wherein the coin magazine is cylindrical and wherein the coin magazine is rotated on the support to move the second channel of the magazine into the coin filling location.

37. The apparatus of claim 20, wherein the coin feeder is oriented at an acute angle of approximately fifteen degrees from horizontal along an axis from a back of the coin feeder to the coin exit which is at a front of the coin feeder.

38. The apparatus of claim 20, wherein the guard is part of an assembly that is pivotable between a closed position and a non-hindering position to allow clearance for the coin magazine to move from the first position to the second position; and
wherein the hub assembly has a portion that is urged against the guard assembly to move it to the non-hindering position that allows the magazine to be moved to the second position for filling.

39. The apparatus of claim 20, wherein the guard is part of an assembly that includes a spring-biased guard flap that slides along an outside of the coin magazine to move from closing a first channel to closing a second channel as the coin magazine is rotated on the support.

40. The apparatus of claim 20, wherein the support is oriented at an acute angle of approximately eighteen degrees from horizontal along an axis from a back of the support to a front of the support.

41. The apparatus of claim 20, further comprising a chute including a reference edge for guiding coins from the coin exit of the feeder to the coin filling location.

42. The apparatus of claim 41, wherein the chute is assembled with a chute extension that can be extended to feed excess coins over the coin filling location to a receptacle.

43. The apparatus of claim 20, wherein the guard has a curved profile with one portion for closing the first channel which has a diameter of different size than a diameter of the second channel and another portion for closing the second channel.
